(19) United States
(12) Patent Application Publication
(10) Pub. No.: US 2024/0048254 A1
(43) Pub. Date: Feb. 8, 2024

(54) Determining TCI For RSSI Measurement In Mobile Communications

(71) Applicant: MediaTek Inc., Hsinchu City (TW)

(72) Inventors: Hsuan-Li Lin, Hsinchu City (TW); Tsang-Wei Yu, Hsinchu City (TW)

(21) Appl. No.: 18/223,732

(22) Filed: Jul. 19, 2023

Related U.S. Application Data
(60) Provisional application No. 63/370,680, filed on Aug. 8, 2022.

(51) Int. Cl. H04B 17/318; H04W 24/08

(52) U.S. Cl. CPC H04B 17/318; H04W 24/08

(57) ABSTRACT

Examples pertaining to determining transmission configuration indicator (TCI) for received signal strength indicator (RSSI) measurement in mobile communications are described. A user equipment (UE) determines a quasi-co-location (QCL) assumption with respect to a received signal strength indicator (RSSI) responsive to not receiving a TCI from a network. The UE also performs an RSSI measurement based on the determined QCL assumption in an expanded Frequency Range 2 (FR2-2) band according to a 3rd Generation Partnership Project (3GPP) specification.

### CROSS REFERENCE TO RELATED PATENT APPLICATION(S)

The present disclosure is part of a non-provisional application claiming the priority benefit of U.S. Patent Application No. 63/370,680, filed 8 Aug. 2022, the content of which herein being incorporated by reference in its entirety.

### TECHNICAL FIELD

The present disclosure is generally related to mobile communications and, more particularly, to determining transmission configuration indicator (TCI) for received signal strength indicator (RSSI) measurement in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) standards including 5^{th} Generation (5G) New Radio (NR), the Frequency Range 2 (encompassing 24.250-52.600 MHz) may be expanded (up to 71 GHz) according to Release 17 of the 3GPP specification for 5G mobile communications (known as the “FR2-2 band”). The FR2-2 band can allow shorter-range communications with an ultra-wide bandwidth. As such, utilization of the FR2-2 band highly relies on beamforming and, thus, assumption of TCI and quasi-co-location (QCI) for RSSI is helpful in determining the beamforming for RSSI measurement. However, in case that TCI is not provided by the network, there needs to be a suitable assumption by a user equipment (UE). At present time, how to provide RSSI TCI has yet to be defined. Therefore, there is a need for a solution of determining TCI for RSSI measurement in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to determining TCI for RSSI measurement in mobile communications. It is believed that the above-described issue(s) would be avoided or otherwise alleviated by implementing one or more of the proposed schemes described herein.

In one aspect, a method may involve a UE determining a quasi-co-location (QCL) assumption with respect to an RSSI responsive to not receiving TCI from a network. The method may also involve the UE performing an RSSI measurement based on the determined QCL assumption in an FR2-2 band according to a 3GPP specification.

In another aspect, an apparatus may include a transceiver and a processor coupled to the transceiver. The transceiver may be configured to communicate wirelessly. The processor may determine a QCL assumption with respect to an RSSI responsive to not receiving TCI from a network. The processor may also perform, via the transceiver, an RSSI measurement based on the determined QCL assumption in an FR2-2 band according to a 3GPP specification.

It is noteworthy that, although description provided herein may be in the context of certain radio access technologies, networks and network topologies such as 5th Generation System (5GS) mobile networking, the proposed concepts, schemes and any variation(s)/derivative(s) thereof may be implemented in, for and by other types of wireless and wired communication technologies, networks and network topologies such as, for example and without limitation, Ethernet, Evolved Packet System (EPS), Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining TCI for RSSI measurement in mobile communications. According to the present disclosure, a number of possible solutions may be implemented separately or jointly. That is, although these possible solutions may be described below separately, two or more of these possible solutions may be implemented in one combination or another.

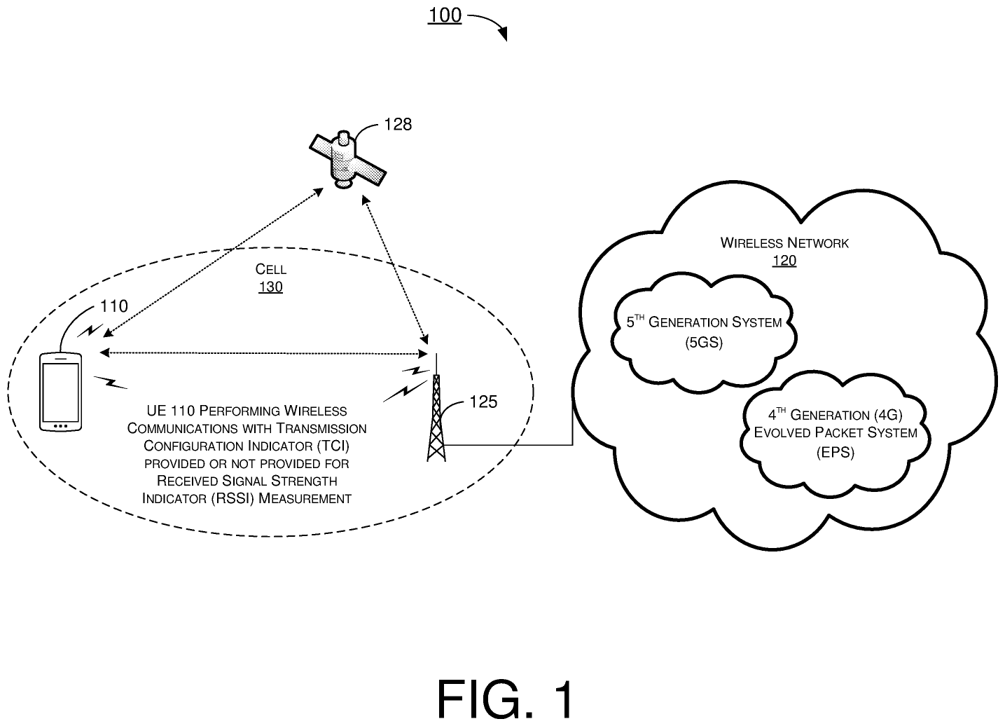

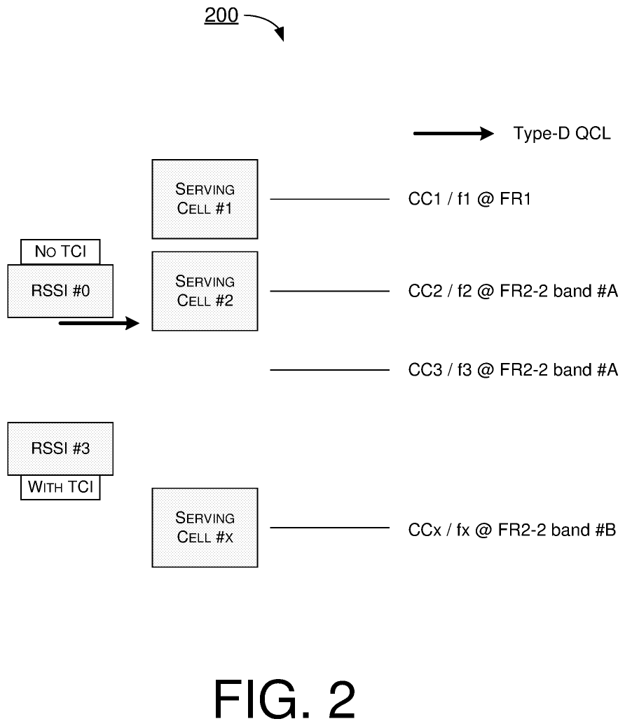

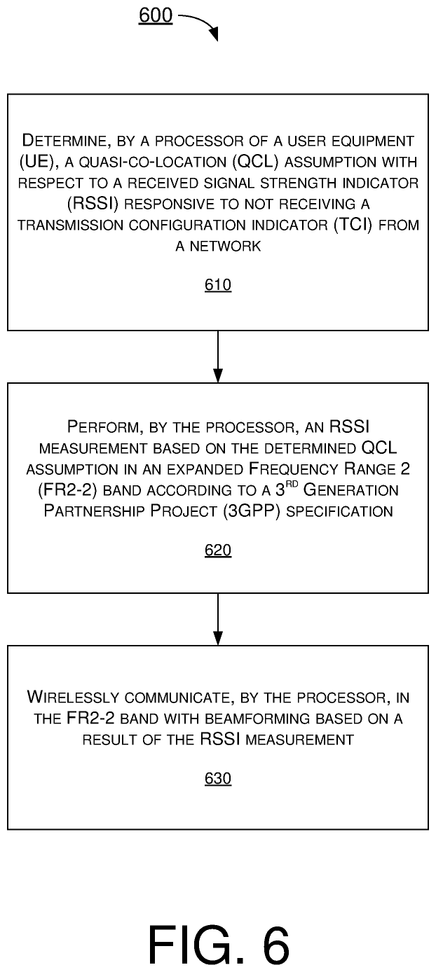

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6.

Referring to FIG. 1, network environment 100 may involve a UE 110 and a wireless network 120, which may include a 5^{th} Generation System (5GS) (and, optionally, an EPS). Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to determining TCI for RSSI measurement in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly.

In general, in the context of mobile communications under 3GPP specification(s), an RSSI measurement is defined as an intra-frequency measurement (also referred to as an “intra-frequency RSSI measurement”) provided that the RSSI measurement bandwidth is fully contained within the current carrier bandwidth of a UE. On the other hand, an RSSI measurement is defined as an inter-frequency measurement (also referred to as an “inter-frequency RSSI measurement”) provided that the RSSI measurement bandwidth is not contained within the current carrier bandwidth of the UE (i.e., it is not an intra-frequency RSSI measurement). Moreover, an “RSSI Measurement Timing Configuration (RMTC) of RSSI measurements” means the RMTC which configures the RSSI measurement.

Under a proposed scheme in accordance with the present disclosure, in case that TCI is not provided by network 120, UE 110 may determine a TCI by referring to the TCI corresponding to one or more other component carriers (CCs) in the same FR2-2 band. Under the proposed scheme, for intra-frequency RSSI (f0), UE 110 may determine a TCI by referring to the TCI of RSSI/reference signal (RS)/channel of active or non-active service cell(s) on (f0) the same FR2-2 band. Moreover, for inter-frequency RSSI (f1), in case that no TCI is provided by network 120 for inter-frequency RSSI, UE 110 may assume that the inter-frequency RSSI is type-D quasi-co-located to the TCI of RSSI in the same FR2-2 band. It is noteworthy that UE 110 may apply the TCI of RS/channel of serving cell(s) in the same FR2-2 to perform RSSI measurement. Advantageously, by implementing the proposed scheme, it is believed that UE 110 may obtain more meaningful RSSI measurements, with proper beamforming direction and more accurate measurement results.

FIG. 2 illustrates an example scenario 200 under a proposed scheme in accordance with the present disclosure. Under the proposed scheme, in an event that TCI is not provided by network 120 for RSSI measurement, QCL assumption may be determined by UE 110 by default. For instance, for intra-frequency RSSI measurement, in case that no TCI state is provided in the RMTC which configures the intra-frequency RSSI measurements (RSSI #0), UE 110 may determine that RSSI measurement resources are quasi-co-located (QCL-ed) with TypeD (e.g., spatially QCL-ed such as for reception) to (1) the RS/channel of a serving cell in the same FR2-2 band, or (2) other inter-frequency RSSI (RSSI #3) with TCI provided in the same FR2-2 band.

For illustrative purposes and without limiting the scope of the present disclosure, in scenario 200 shown in FIG. 2, serving cell #1 may be on CC #1 on f1 at Frequency Range 1 (FR1) and serving cell #2 may be on CC #2 on FR2-2 band #A. RSSI #0 may be contained by serving cell #2 with RSSI resource(s) within the bandwidth of cell #2. The RSSI may be seen as being QCL-ed with TypeD to (1) the TCI of physical downlink shared channel (PDSCH)/physical downlink control channel (PDCCH)/physical broadcast channel demodulation reference signal (PBCH-DMRS) of serving cell #2, or (2) RSSI #3. Then, UE 110 may perform RSSI measurement based on the determined TCI (e.g., by applying the specific receive (Rx) beam for this TCI).

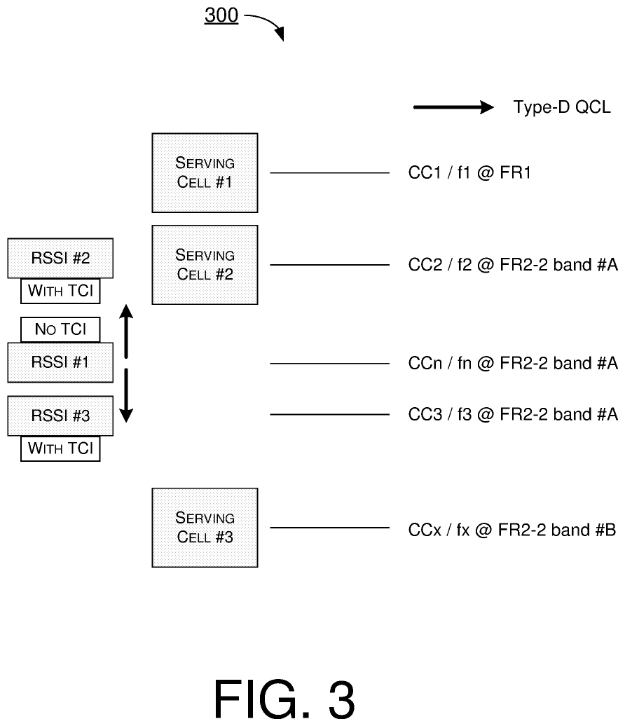

FIG. 3 illustrates an example scenario 300 under a proposed scheme in accordance with the present disclosure. Under the proposed scheme, for inter-frequency RSSI measurement (RSSI #1), in case that no TCI state is provided in the RMTC of the inter-frequency RSSI measurements (RSSI #1) and that no TCI state is provided in any RMTC which configures the intra-frequency RSSI measurements (RSSI #2) or the inter-frequency RSSI measurements (RSSI #3) in the same FR2-2 band (e.g., RSSI #1 and RSSI #2/being in the same FR2-2), UE 110 may determine that RSSI #1 are QCL-ed with TypeD to (1) the RS of TCI provided in the RMTC associated with RSSI #2, or (2) the RS of TCI provided in the RMTC associated with RSSI #3.

For illustrative purposes and without limiting the scope of the present disclosure, in scenario 300 shown in FIG. 3, serving cell #1 may be on CC #1 on f1 at FR1 and serving cell #2 may be on CC #2 on FR2-2 band #A. RSSI #1 may not be contained by UE bandwidth. The RSSI may be seen as being QCL-ed with TypeD to (1) RSSI #2, or (2) RSSI #3. Then, UE 110 may perform RSSI measurement based on the determined TCI (e.g., by applying the specific Rx beam for this TCI ).

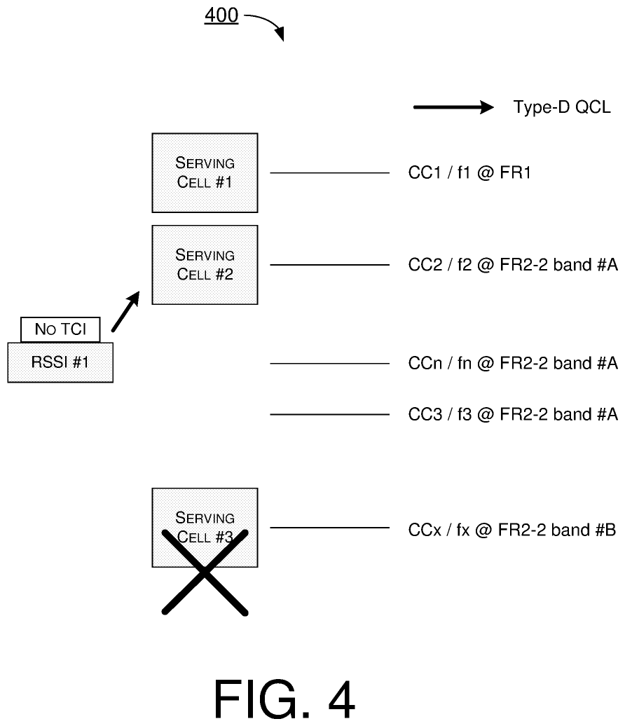

FIG. 4 illustrates an example scenario 400 under a proposed scheme in accordance with the present disclosure. Under the proposed scheme, for inter-frequency RSSI measurement (RSSI #1), in case that no TCI state is provided in the RMTC of the inter-frequency RSSI measurements (RSSI #1) and that no TCI state is provided in the RMTC configurations which configure the intra-frequency RSSI measurements in FR2-2, UE 110 may determine that RSSI measurements resources are QCL-ed with TypeD to the RS/channel of a serving cell in the same FR2-2 band (e.g., serving cell).

For illustrative purposes and without limiting the scope of the present disclosure, in scenario 400 shown in FIG. 4, serving cell #1 may be on CC #1 on f1 at FR1 and serving cell #2 may be on CC #2 on FR2-2 band #A. RSSI #1 may not be contained by UE bandwidth. The RSSI may be seen as being QCL-ed with TypeD to the TCI of PDSCH/PDCCH/PBCH-DMRS of serving cell #2.

Under a proposed scheme in accordance with the present disclosure with respect to intra-frequency RSSI measurements, in performing RSSI measurement in FR2-2, UE 110 may assume that the configured RSSI measurement resources are QCL-ed with TypeD to a downlink (DL) RS associated with the TCI state provided in the RMTC configuration. In case that no TCI state is provided in the RMTC configuration, UE 110 may assume that the configured RSSI measurement resources are QCL-ed with TypeD to one of the latest received PDSCH and the latest monitored control resource set (CORESET) in the active bandwidth part (BWP) of a serving cell in FR2-2.

Under a proposed scheme in accordance with the present disclosure with respect to inter-frequency RSSI measurements, in performing RSSI measurement in FR2-2, UE 110 may assume that the configured RSSI measurement resources are QCL-ed with TypeD to the DL RS associated with the TCI state provided in the RMTC configuration of the inter-frequency RSSI measurement. Additionally, in case that no TCI state is provided by network 120 in the (inter-frequency or intra-frequency) RMTC configuration of the inter-frequency RSSI measurement, UE 110 may assume that the measurement resources are QCL-ed with TypeD to the DL RS associated with the TCI state provided in the RMTC configuration (of an RSSI measurement which is) in the same FR2-2 band as the inter-frequency RSSI measurement. Moreover, in case that no TCI state is provided by network 120 in any of RMTC configuration in the same FR2-2 band, UE 110 may assume that the configured RSSI measurement resources are QCL-ed with TypeD to one of the latest received PDSCH and the latest monitored CORESET in the active BWP of a serving cell in the same FR2-2 band.

### Illustrative Implementations

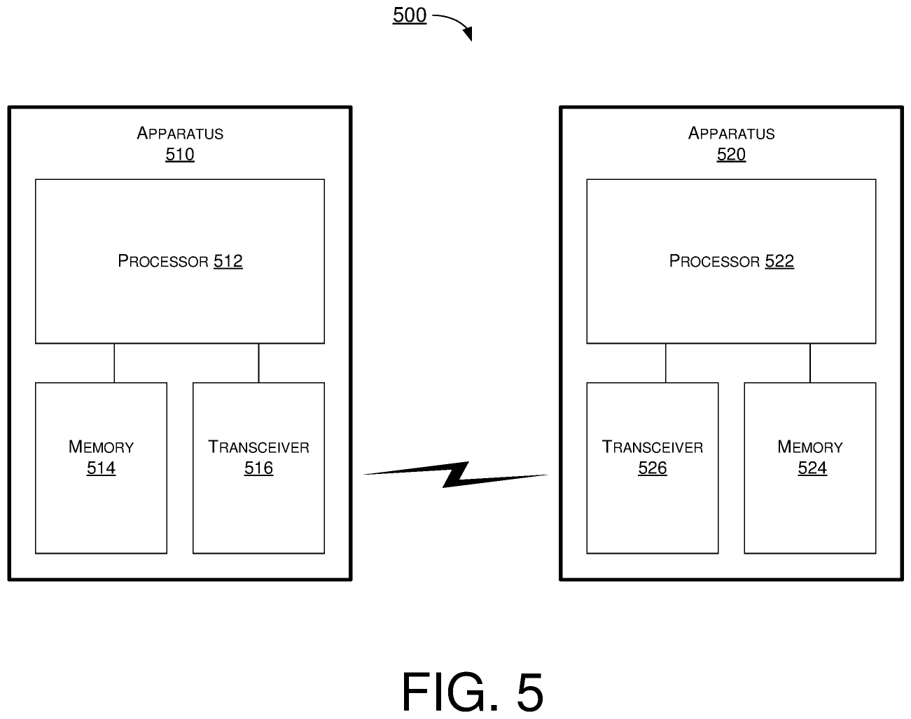

FIG. 5 illustrates an example communication system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to determining TCI for RSSI measurement in mobile communications, including the various schemes described above with respect to various proposed designs, concepts, schemes, systems and methods described above, including network environment 100, as well as processes described below.

Each of apparatus 510 and apparatus 520 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 510 and apparatus 520 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNodeB in an LTE, LTE-Advanced or LTE-Advanced Pro network or in a gNB or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to determining TCI for RSSI measurement in mobile communications in accordance with various implementations of the present disclosure.

In some implementations, apparatus 510 may also include a transceiver 516 coupled to processor 512. Transceiver 516 may be capable of wirelessly transmitting and receiving data. In some implementations, transceiver 516 may be capable of wirelessly communicating with different types of wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for multiple-input multiple-output (MIMO) wireless communications. In some implementations, apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs/wireless networks of different RATs. In some implementations, transceiver 526 may be equipped with a plurality of antenna ports (not shown) such as, for example, four antenna ports. That is, transceiver 526 may be equipped with multiple transmit antennas and multiple receive antennas for MIMO wireless communications.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 514 and memory 524 may include a Universal Integrated Circuit Card (UICC).

Each of apparatus 510 and apparatus 520 may be a communication entity capable of communicating with each other using various proposed schemes in accordance with the present disclosure. For illustrative purposes and without limitation, a description of capabilities of apparatus 510, as a UE (e.g., UE 110), and apparatus 520, as a network node (e.g., terrestrial network node 125 or non-terrestrial network node 128) of a wireless network (e.g., wireless network 120), is provided below.

Under certain proposed schemes in accordance with the present disclosure with respect to determining TCI for RSSI measurement in mobile communications, processor 512 of apparatus 510, implemented in or as UE 110, may determine a QCL assumption with respect to an RSSI responsive to not receiving a TCI from a network (e.g., wireless network 120 via apparatus 520 as terrestrial network node 125 or non-terrestrial network node 128). Additionally, processor 512 may perform, via transceiver 516, an RSSI measurement based on the determined QCL assumption in a FR2-2 band according to a 3GPP specification. Moreover, processor 512 may wirelessly communicate, via transceiver 516, in the FR2-2 band (e.g., with apparatus 520) with beamforming based on a result of the RSSI measurement.

In some implementations, in determining the QCL assumption, processor 512 may refer to a respective TCI of each of one or more other CCs in the same FR2-2 band.

In some implementations, the RSSI may include an intra-frequency RSSI. In such cases, in determining the QCL assumption, processor 512 may refer to a respective TCI of another RSSI, an RS or a channel of an active or non-active serving cell in the same FR2-2 band.

In some implementations, the RSSI may include an inter-frequency RSSI. In such cases, in determining the QCL assumption, processor 512 may assume the inter-frequency RSSI as being type-D quasi-co-located to another TCI of another RSSI in the same FR2-2 band. Moreover, in performing the RSSI measurement, processor 512 may apply a respective TCI of an RS or a channel of a serving cell in the same FR2-2 band in performing the RSSI measurement.

In some implementations, in performing the RSSI measurement, processor 512 may perform an intra-frequency RSSI measurement. In such cases, in determining, processor 512 may, further responsive to not receiving a TCI state in one or more RMTC configurations that configure one or more intra-frequency RSSI measurements, determine that one or more resources used in the RSSI measurement as being quasi-co-located with TypeD to either: (a) an RS or a channel of a serving cell in the same FR2-2 band, or (b) another inter-frequency RSSI with a respective TCI provided by the network in the same FR2-2 band.

In some implementations, in performing the RSSI measurement, processor 512 may perform an inter-frequency RSSI measurement. In such cases, in determining, processor 512 may determine the QCL assumption further responsive to not receiving a TCI state in one or more RMTC configurations that configure one or more inter-frequency RSSI measurements. Additionally, further responsive to not receiving a TCI in any of one or more RMTC configurations that configure one or more intra-frequency RSSI measurements or the one or more inter-frequency RSSI measurements in the same FR2-2 band, in determining, processor 512 may determine that the one or more inter-frequency RSSI measurements as being quasi-co-located with TypeD to either: (a) an RS of a respective TCI provided by the network in an RMTC associated with the one or more intra-frequency RSSI measurements, or (b) another RS of another respective TCI provided by the network in another RMTC associated with the one or more inter-frequency RSSI measurements. Alternatively, further responsive to not receiving a TCI state in one or more RMTC configurations that configure one or more intra-frequency RSSI measurements in the same FR2-2 band, in determining, processor 512 may determine that one or more resources used in the RSSI measurement as being quasi-co-located with TypeD to an RS or a channel of a serving cell in the same FR2-2 band.

### Illustrative Processes

FIG. 6 illustrates an example process 600 in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to determining TCI for RSSI measurement in mobile communications. Process 600 may include one or more operations, actions, or functions as illustrated by one or more of blocks 610,620 and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 510 and apparatus 520 as well as any variations thereof. Solely for illustrative purposes and without limiting the scope, process 600 is described below in the context of apparatus 510 as a UE (e.g., UE 110) and apparatus 520 as a communication entity such as a network node or base station (e.g., terrestrial network node 125 or non-terrestrial network node 128) of a network (e.g., wireless network 120). Process 600 may begin at block 610.

At 610, process 600 may involve processor 512 of apparatus 510, implemented in or as UE 110, determining a QCL assumption with respect to an RSSI responsive to not receiving a TCI from a network (e.g., wireless network 120 via apparatus 520 as terrestrial network node 125 or non-terrestrial network node 128). Process 600 may proceed from 610 to 620.

At 620, process 600 may involve processor 512 performing, via transceiver 516, an RSSI measurement based on the determined QCL assumption in a FR2-2 band according to a 3GPP specification. Process 600 may proceed from 620 to 630.

At 630, process 600 may involve processor 512 wirelessly communicating, via transceiver 516, in the FR2-2 band (e.g., with apparatus 520) with beamforming based on a result of the RSSI measurement.

In some implementations, in determining the QCL assumption, process 600 may involve processor 512 referring to a respective TCI of each of one or more other CCs in the same FR2-2 band.

In some implementations, the RSSI may include an intra-frequency RSSI. In such cases, in determining the QCL assumption, process 600 may involve processor 512 referring to a respective TCI of another RSSI, an RS or a channel of an active or non-active serving cell in the same FR2-2 band.

In some implementations, the RSSI may include an inter-frequency RSSI. In such cases, in determining the QCL assumption, process 600 may involve processor 512 assuming the inter-frequency RSSI as being type-D quasi-co-located to another TCI of another RSSI in the same FR2-2 band. Moreover, in performing the RSSI measurement, process 600 may involve processor 512 applying a respective TCI of an RS or a channel of a serving cell in the same FR2-2 band in performing the RSSI measurement.

In some implementations, in performing the RSSI measurement, process 600 may involve processor 512 performing an intra-frequency RSSI measurement. In such cases, in determining, process 600 may involve processor 512, further responsive to not receiving a TCI state in one or more RMTC configurations that configure one or more intra-frequency RSSI measurements, determining that one or more resources used in the RSSI measurement as being quasi-co-located with TypeD to either: (a) an RS or a channel of a serving cell in the same FR2-2 band, or (b) another inter-frequency RSSI with a respective TCI provided by the network in the same FR2-2 band.

In some implementations, in performing the RSSI measurement, process 600 may involve processor 512 performing an inter-frequency RSSI measurement. In such cases, in determining, process 600 may involve processor 512 determining the QCL assumption further responsive to not receiving a TCI state in one or more RMTC configurations that configure one or more inter-frequency RSSI measurements. Additionally, further responsive to not receiving a TCI in any of one or more RMTC configurations that configure one or more intra-frequency RSSI measurements or the one or more inter-frequency RSSI measurements in the same FR2-2 band, in determining, process 600 may involve processor 512 determining that the one or more inter-frequency RSSI measurements as being quasi-co-located with TypeD to either: (a) an RS of a respective TCI provided by the network in an RMTC associated with the one or more intra-frequency RSSI measurements, or (b) another RS of another respective TCI provided by the network in another RMTC associated with the one or more inter-frequency RSSI measurements. Alternatively, further responsive to not receiving a TCI state in one or more RMTC configurations that configure one or more intra-frequency RSSI measurements in the same FR2-2 band, in determining, process 600 may involve processor 512 determining that one or more resources used in the RSSI measurement as being quasi-co-located with TypeD to an RS or a channel of a serving cell in the same FR2-2 band.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a user equipment (UE), a quasi-co-location (QCL) assumption with respect to a received signal strength indicator (RSSI) responsive to not receiving a transmission configuration indicator (TCI) from a network; and
performing, by the processor, an RSSI measurement based on the determined QCL assumption in an expanded Frequency Range 2 (FR2-2) band according to a 3^{rd} Generation Partnership Project (3GPP) specification.

2. The method of claim 1, wherein the determining of the QCL assumption comprises referring to a respective TCI of each of one or more other component carriers (CCs) in the FR2-2 band.

3. The method of claim 1, wherein the RSSI comprises an intra-frequency RSSI, and wherein the determining of the QCL assumption comprises referring to a respective TCI of another RSSI, a reference signal (RS) or a channel of an active or non-active serving cell in the FR2-2 band.

4. The method of claim 1, wherein the RSSI comprises an inter-frequency RSSI, and wherein the determining of the QCL assumption comprises assuming the inter-frequency RSSI as being type-D quasi-co-located to another TCI of another RSSI in the FR2-2 band.

5. The method of claim 4, wherein the performing of the RSSI measurement comprises applying a respective TCI of a reference signal (RS) or a channel of a serving cell in the FR2-2 band in performing the RSSI measurement.

6. The method of claim 1, wherein the performing of the RSSI measurement comprises performing an intra-frequency RSSI measurement, and wherein the determining comprises, further responsive to not receiving a TCI state in one or more RSSI Measurement Timing Configuration (RMTC) configurations that configure one or more intra-frequency RSSI measurements, determining that one or more resources used in the RSSI measurement as being quasi-co-located with TypeD to either:
a reference signal (RS) or a channel of a serving cell in the FR2-2 band, or
another inter-frequency RSSI with a respective TCI provided by the network in the FR2-2 band.

7. The method of claim 1, wherein the performing of the RSSI measurement comprises performing an inter-frequency RSSI measurement, and wherein the determining comprises determining the QCL assumption further responsive to not receiving a TCI state in one or more RSSI Measurement Timing Configuration (RMTC) configurations that configure one or more inter-frequency RSSI measurements.

8. The method of claim 7, wherein the determining further comprises, further responsive to not receiving a TCI in any of one or more RMTC configurations that configure one or more intra-frequency RSSI measurements or the one or more inter-frequency RSSI measurements in the FR2-2 band, determining that the one or more inter-frequency RSSI measurements as being quasi-co-located with TypeD to either:
a reference signal (RS) of a respective TCI provided by the network in an RMTC associated with the one or more intra-frequency RSSI measurements, or
another RS of another respective TCI provided by the network in another RMTC associated with the one or more inter-frequency RSSI measurements.

9. The method of claim 7, wherein the determining further comprises, further responsive to not receiving a TCI state in one or more RMTC configurations that configure one or more intra-frequency RSSI measurements in the FR2-2 band, determining that one or more resources used in the RSSI measurement as being quasi-co-located with TypeD to a reference signal (RS) or a channel of a serving cell in the FR2-2 band.

10. The method of claim 1, further comprising:
wirelessly communicating, by the processor, in the FR2-2 band with beamforming based on a result of the RSSI measurement.

11. An apparatus implementable in a user equipment (UE), comprising:
a transceiver configured to communicate wirelessly; and
a processor coupled to the transceiver and configured to perform, via the transceiver, operations comprising:
determining a quasi-co-location (QCL) assumption with respect to a received signal strength indicator (RSSI) responsive to not receiving a transmission configuration indicator (TCI) from a network; and
performing, via the transceiver, an RSSI measurement based on the determined QCL assumption in an expanded Frequency Range 2 (FR2-2) band according to a 3rd Generation Partnership Project (3GPP) specification.

12. The apparatus of claim 11, wherein the determining of the QCL assumption comprises referring to a respective TCI of each of one or more other component carriers (CCs) in the FR2-2 band.

13. The apparatus of claim 11, wherein the RSSI comprises an intra-frequency RSSI, and wherein the determining of the QCL assumption comprises referring to a respective TCI of another RSSI, a reference signal (RS) or a channel of an active or non-active serving cell in the FR2-2 band.

14. The apparatus of claim 11, wherein the RSSI comprises an inter-frequency RSSI, and wherein the determining of the QCL assumption comprises assuming the inter-frequency RSSI as being type-D quasi-co-located to another TCI of another RSSI in the FR2-2 band.

15. The apparatus of claim 14, wherein the performing of the RSSI measurement comprises applying a respective TCI of a reference signal (RS) or a channel of a serving cell in the FR2-2 band in performing the RSSI measurement.

16. The apparatus of claim 11, wherein the performing of the RSSI measurement comprises performing an intra-frequency RSSI measurement, and wherein the determining comprises, further responsive to not receiving a TCI state in one or more RSSI Measurement Timing Configuration (RMTC) configurations that configure one or more intra-frequency RSSI measurements, determining that one or more resources used in the RSSI measurement as being quasi-co-located with TypeD to either:
a reference signal (RS) or a channel of a serving cell in the FR2-2 band, or
another inter-frequency RSSI with a respective TCI provided by the network in the FR2-2 band.

17. The apparatus of claim 11, wherein the performing of the RSSI measurement comprises performing an inter-frequency RSSI measurement, and wherein the determining comprises determining the QCL assumption further responsive to not receiving a TCI state in one or more RSSI Measurement Timing Configuration (RMTC) configurations that configure one or more inter-frequency RSSI measurements.

18. The apparatus of claim 17, wherein the determining further comprises, further responsive to not receiving a TCI in any of one or more RMTC configurations that configure one or more intra-frequency RSSI measurements or the one or more inter-frequency RSSI measurements in the FR2-2 band, determining that the one or more inter-frequency RSSI measurements as being quasi-co-located with TypeD to either:
a reference signal (RS) of a respective TCI provided by the network in an RMTC associated with the one or more intra-frequency RSSI measurements, or
another RS of another respective TCI provided by the network in another RMTC associated with the one or more inter-frequency RSSI measurements.

19. The apparatus of claim 17, wherein the determining further comprises, further responsive to not receiving a TCI state in one or more RMTC configurations that configure one or more intra-frequency RSSI measurements in the FR2-2 band, determining that one or more resources used in the RSSI measurement as being quasi-co-located with TypeD to a reference signal (RS) or a channel of a serving cell in the FR2-2 band.

20. The apparatus of claim 11, wherein the processor is further configured to perform operations comprising:
wirelessly communicating, via the transceiver, in the FR2-2 band with beamforming based on a result of the RSSI measurement.
